(19) United States
(12) Patent Application Publication
(10) Pub. No.: US 2019/0015877 A1
(43) Pub. Date: Jan. 17, 2019

(54) ADHERED-SUBSTANCE REMOVING APPARATUS AND ADHERED-SUBSTANCE REMOVING METHOD

(71) Applicant: DENSO TEN Limited, Kobe-shi (JP)

(72) Inventors: Toru YAMAGUCHI, Kobe-shi (JP); Naoki OKADA, Kobe-shi (JP); Shinichiro ICHIKI, Kobe-shi (JP)

(73) Assignee: DENSO TEN Limited, Kobe-shi (JP)

(21) Appl. No.: 15/981,224

(22) Filed: May 16, 2018

(30) Foreign Application Priority Data
Jul. 13, 2017 (JP) 2017-137383

(51) Int. Cl. B08B 5/02; B60S 1/56

(52) U.S. Cl. CPC B08B 5/02; B60R 1/00; B60S 1/56

(57) ABSTRACT

There is provided an adhered-substance removing apparatus. An acquiring unit acquires output information on a tone to be output from an external device mounted on a vehicle. An instructing unit issues, based on the output information, an instruction to perform an operation of removing adhered substances from a lens of a camera installed on the outside of the vehicle in a period when the external device outputs the tone. A removing unit performs the operation of removing based on the instruction from the instructing unit.

### CROSS-REFERENCE TO RELATED APPLICATIONS

This application is based on and claims priority under 35 USC 119 from Japanese Patent Application No. 2017-137383 filed on Jul. 13, 2017.

### BACKGROUND

### Technical Field

The present disclosure relates to an adhered-substance removing apparatus and an adhered-substance removing method.

### Related Art

In the related art, there is an adhered-substance removing apparatus for removing adhered substances from the lens of a camera installed on the outside of a vehicle (see Patent Document 1 for instance). Here, examples of adhered substances include raindrops, snowflakes, dust, dirt, and so on.

[Patent Document 1] Japanese Patent Application Laid-Open No. 2009-220719

However, the adhered-substance removing apparatus according to the related art produces operating sound according to an adhered-substance removing operation. The operating sound may impress occupants in the vehicle as unpleasant noise.

The present invention was made in view of the above-mentioned circumstances, and an object of the present invention is to provide an adhered-substance removing apparatus and an adhered-substance removing method capable of making noise according to an adhered-substance removing operation unobtrusive.

### SUMMARY

According to an aspect of the present disclosure, there is provided an adhered-substance removing apparatus including: an acquiring unit configured to acquire output information on a tone to be output from an external device mounted on a vehicle; an instructing unit configured to issue, based on the output information, an instruction to perform an operation of removing adhered substances from a lens of a camera installed on the outside of the vehicle in a period when the external device outputs the tone; and a removing unit configured to perform the operation of removing based on the instruction from the instructing unit.

According to an aspect of embodiments, it is possible to provide an adhered-substance removing apparatus and an adhered-substance removing method capable of making noise according to an adhered-substance removing operation unobtrusive.

### BRIEF DESCRIPTION OF THE DRAWINGS

Exemplary embodiments of the present invention will be described in detail based on the following figures, wherein:

FIG. 1 is a view for explaining an outline of an adhered-substance removing method according to an embodiment;

FIG. 2 is a block diagram illustrating an example of the configuration of an adhered-substance removing apparatus according to the embodiment;

FIG. 3 is a view illustrating a specific example of a removing operation which is performed by a removing unit according to the embodiment;

FIG. 4 is a view illustrating an example of a process which is performed by an instructing unit according to the embodiment;

FIG. 5 is a view for explaining the operation relation between a back camera and the adhered-substance removing apparatus according to the embodiment;

FIG. 6 is a flow chart illustrating an example of a proceeding procedure which is performed by the adhered-substance removing apparatus according to the embodiment;

FIG. 7 is a block diagram illustrating an example of the configuration of an adhered-substance removing apparatus according to a modification of the embodiment;

FIG. 8A is a view illustrating an example of a process which is performed by an instructing unit according to the modification of the embodiment;

FIG. 8B is a view illustrating another example of the process which is performed by the instructing unit according to the modification of the embodiment; and

FIG. 9 is a flow chart illustrating an example of a proceeding procedure which is performed by the adhered-substance removing apparatus according to the modification of the embodiment.

### DETAILED DESCRIPTION

Hereinafter, an adhered-substance removing apparatus and an adhered-substance removing method according to an embodiment of the present invention will be described in detail with reference to the accompanying drawings. However, the present invention is not limited to the embodiment to be described below.

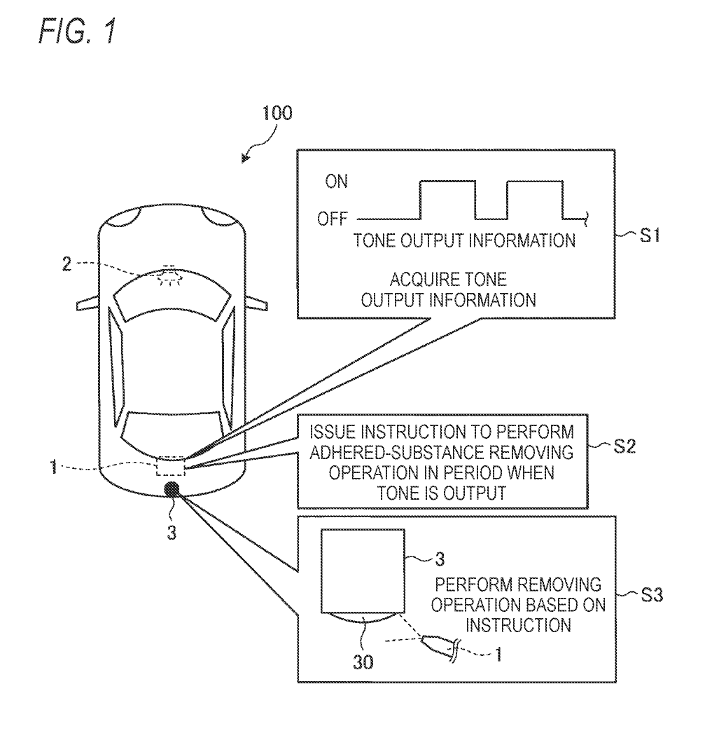

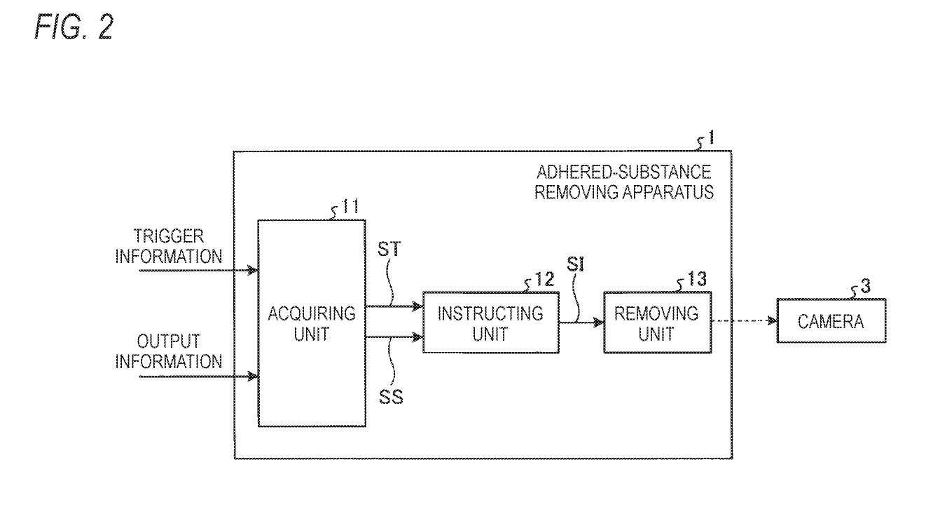

Also, hereinafter, an outline of the adhered-substance removing method according to the present embodiment will be described first with reference to FIG. 1, and then an adhered-substance removing apparatus 1 using the adhered-substance removing method according to the embodiment will be described with reference to FIG. 2 to FIG. 6.

First, with reference to FIG. 1, the outline of the adhered-substance removing method according to the present embodiment will be described. FIG. 1 is a view for explaining the outline of the adhered-substance removing method according to the embodiment.

As shown in FIG. 1, the adhered-substance removing apparatus 1 is mounted on a vehicle 100. The adhered-substance removing apparatus 1 removes adhered substances (such as raindrops, snowflakes, dust, and dirt) from a lens 30 of a camera 3 mounted on the vehicle 100. To this end, the adhered-substance removing apparatus 1 is attached near the camera 3.

The camera 3 is a back camera for imaging an area behind the vehicle 100. For example, if trigger information representing that a driver (a user) has put the vehicle 100 in reverse by operating the gears is input, the camera 3 is activated and images a predetermined area.

Also, images acquired by the camera 3 are displayed on a display unit of a navigator (not shown in the drawings) for occupants in the vehicle 100. Also, the camera 3 is attached to the outside of the vehicle 100, for example, on the back door. Therefore, sometimes, substances including rain, snow, dirt, and so on adhere to the lens 30 of the camera 3.

Now, an operation of removing adhered substances from a lens which is performed by the adhered-substance removing apparatus of the related art will be described. If trigger information is input, the adhered-substance removing apparatus of the related art performs preparation for injection, such as air compression, and if the preparation finishes, the adhered-substance removing apparatus injects compressed air toward the lens, thereby removing adhered substances.

In other words, in the technology of the related art, before a backing warning tone for informing the driver that the vehicle is backing up is produced, injection sound is made by injection of compressed air. The injection sound may impress occupants in the vehicle as unpleasant noise.

For this reason, the adhered-substance removing apparatus 1 according to the present embodiment is configured to perform an adhered-substance removing operation in a period when an external device 2 mounted on the vehicle 100 is outputting a tone, thereby making noise according to the adhered-substance removing operation unobtrusive.

Specifically, the adhered-substance removing apparatus 1 according to the present embodiment acquires output information on a tone to be output from the external device 2 such as a speaker (STEP 51). The output information on the tone is information including information on timings to switch between an ON state in which the tone is output and an OFF state in which the tone is not output.

Next, on the basis of the acquired output information, the adhered-substance removing apparatus 1 issues an instruction to perform an adhered-substance removing operation in a period when the external device 2 outputs the tone (STEP S2). Then, on the basis of that instruction, the adhered-substance removing apparatus 1 performs the operation of removing adhered substances from the lens 30 of the camera 3 (STEP S3).

In other words, the adhered-substance removing apparatus 1 according to the present embodiment masks operating sound produced by the adhered-substance removing operation with the tone output from the external device 2, thereby capable of making noise according to the adhered-substance removing operation unobtrusive. Therefore, as a result, it is possible to reduce noise according to the adhered-substance removing operation.

Now, with reference to FIG. 2, the configuration of the adhered-substance removing apparatus 1 according to the embodiment will be described. FIG. 2 is a block diagram illustrating an example of the configuration of the adhered-substance removing apparatus 1 according to the embodiment. Also, FIG. 2 shows the camera 3 in addition to the adhered-substance removing apparatus 1. In FIG. 2, only components necessary to describe features of the present embodiment are shown by functional blocks, and general components are not shown.

In other words, the components shown in FIG. 2 are for conceptually illustrating the functions thereof and do not necessarily need to be physically configured as shown in the drawing. For example, the specific form of separation and integration of the functional blocks is not limited to the form shown in the drawings, and all or some of the functional blocks can be functionally or physically separated or integrated into arbitrary units, according to various conditions such as various loads and use conditions.

As shown in FIG. 2, the adhered-substance removing apparatus 1 includes an acquiring unit 11, an instructing unit 12, and a removing unit 13.

The acquiring unit 11 acquires trigger information for activating the adhered-substance removing apparatus, and output information on a tone to be output from the external device 2. Here, the trigger information is, for example, information representing that the vehicle 100 has been put in reverse. Also, the output information on the tone to be output from the external device 2 is information on a backing warning tone for informing the driver that the vehicle 100 is backing up since the vehicle 100 has been put in reverse. The output information is, for example, information representing timings to switch a tone which is repeated in a cycle between the ON state and the OFF state.

If the acquiring unit 11 acquires the trigger information, it outputs a trigger signal ST representing ON and OFF states based on the trigger information to the instructing unit 12. Also, if the acquiring unit 11 acquires the output information, it outputs a synchronization signal SS representing ON and OFF states based on the output information to the instructing unit 12.

If the instructing unit 12 receives the trigger signal ST and the synchronization signal SS from the acquiring unit 11 and both of the signals represent the ON states, it outputs an instruction signal SI in an ON state to the removing unit 13.

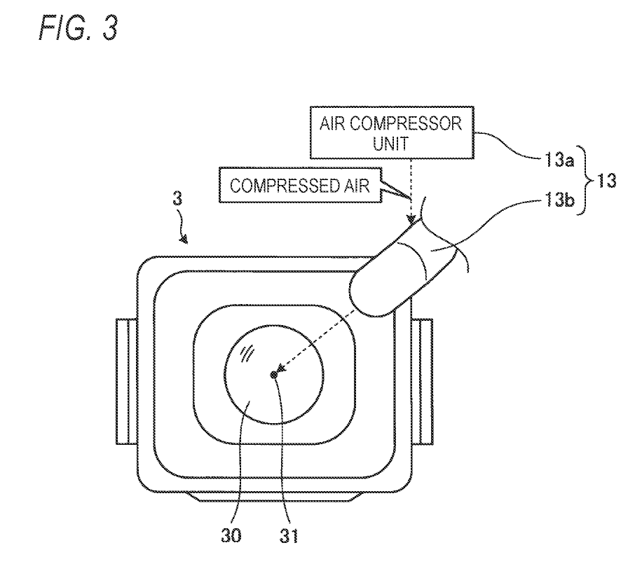

If the removing unit 13 receives the instruction signal SI from the instructing unit 12, it performs an operation of removing adhered substances from the lens 30 of the camera 3. A specific example of the removing operation which is performed by the removing unit 13 will be described below with reference to FIG. 3.

The camera 3 is a back camera having an imaging element such as a charge-coupled device (CCD) or a complementary metal oxide semiconductor (CMOS), and images, for example, a predetermined area behind the vehicle 100. Hereinafter, the camera 3 will also be referred to as the back camera 3.

Also, the camera 3 is activated if trigger information is input. In this example, the camera 3 is activated if information representing that the vehicle 100 has been put in reverse is input. Also, the camera 3 outputs a signal representing images acquired by imaging the predetermined area to the navigator (not shown in the drawings).

Now, with reference to FIG. 3, the removing operation which is performed by the removing unit 13 will be described. FIG. 3 is a view illustrating a specific example of the removing operation which is performed by the removing unit 13.

As shown in FIG. 3, the removing unit 13 includes an air compressor unit 13a and a nozzle 13b. If the air compressor unit 13a receives the instruction signal SI from the instructing unit 12, it compresses air and injects compressed air to the nozzle 13b.

The nozzle 13b is disposed, for example, so as to inject compressed air obliquely from a position above the lens 30 toward a center point 31 of the lens 30. Further, the nozzle 13b injects compressed air produced by the air compressor unit 13a toward the center point 31 of the lens 30, thereby removing adhered substances from the lens 30.

As described above, the removing unit 13 removes adhered substances from the lens 30 of the camera 3 by injecting compressed air. However, the removing unit 13 may be configured to inject a liquid such as water or a cleaning liquid together with compressed air, thereby removing adhered substances.

Also, the removing operation of the removing unit 13 shown in FIG. 3 is an example, and the present invention is not limited thereto. The removing unit 13 may be configured to wipe the surface of the lens 30 with a camera wiper, thereby removing adhered substances.

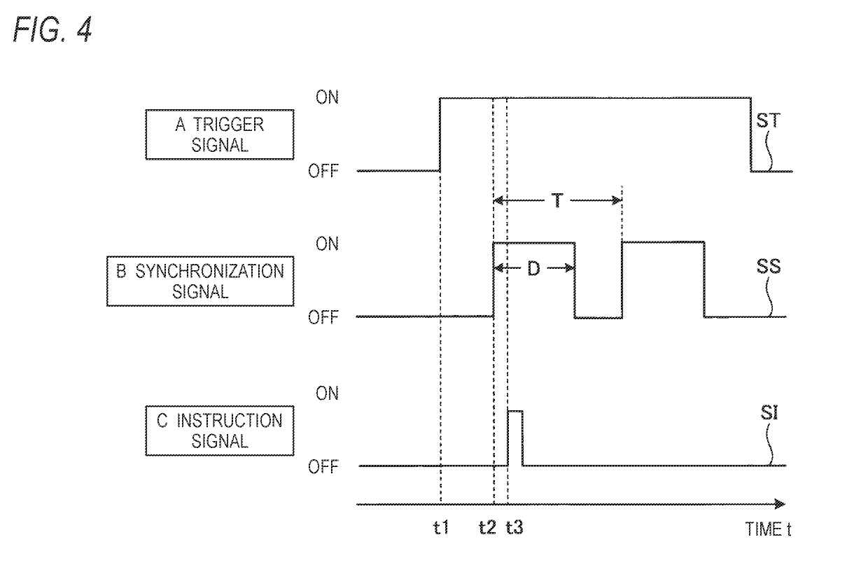

Now, with reference to FIG. 4, details of a process which is performed by the instructing unit 12 will be described. FIG. 4 is a view illustrating an example of the process which is performed by the instructing unit 12 according to the embodiment. In FIG. 4, the horizontal axis represents elapse of time.

Also, in FIG. 4, “A” represents the ON/OFF state of the trigger signal ST, and “B” represents the ON/OFF state of the synchronization signal SS, and “C” represents the ON/OFF state of the instruction signal SI.

As shown in FIG. 4, it is assumed that, at a time t1, the trigger signal ST is switched from the OFF state to the ON state. Also, it is assumed that, at a time t2, i.e. after a predetermined time from the time t1, the synchronization signal SS is switched from the OFF state to the ON state.

If the instructing unit 12 detects that the trigger signal ST is in the ON state and the synchronization signal SS is in the ON state, at a time t3, i.e. after a predetermined time from the time t2, the instructing unit switches the instruction signal SI from the OFF state to the ON state.

As described above, if the predetermined time elapses from the time t2, the instructing unit switches the instruction signal SI from the OFF state to the ON state, such that the instruction signal SI is surely switched in a period when the synchronization signal SS is in the ON state.

Further, at the time t3, the removing unit 13 having received the instruction signal SI in the ON state performs the adhered-substance removing operation. In other words, in this example, in the first cycle T of the synchronization signal SS, in a period D when the backing warning tone is output, the instructing unit switches the instruction signal SI from the OFF state to the ON state. As a result, it is possible to mask injection sound produced by injection from the nozzle 13b with the backing warning tone output from the external device 2.

In the above-described example, in the first cycle T of the synchronization signal SS, in the period D when the backing warning tone is output, the instructing unit switches the instruction signal SI from the OFF state to the ON state; however, the instructing unit may switch the instruction signal SI from the OFF state to the ON state in the next cycle of the synchronization signal SS.

Also, the number of times switching of the instruction signal SI from the OFF state to the ON state is performed in the first cycle T of the synchronization signal SS is not limited to one, and switching of the instruction signal SI from the OFF state to the ON state may be performed two or more times. Also, switching of the instruction signal SI from the OFF state to the ON state may be performed at the rising timing of the first cycle T.

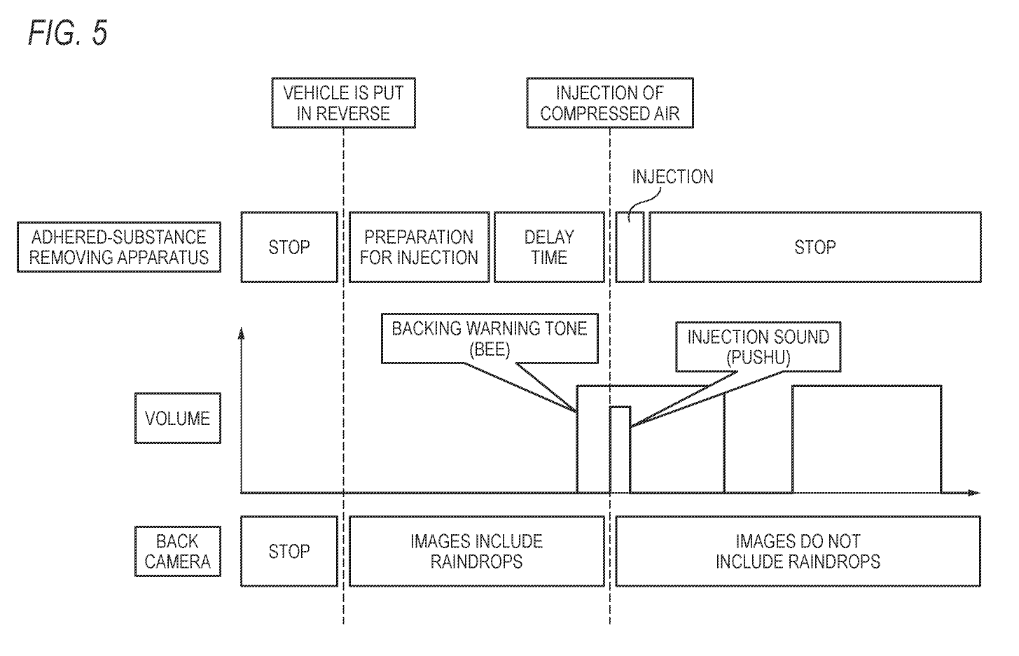

Now, with reference to FIG. 5, the operation relation between the adhered-substance removing apparatus 1 and the back camera 3 will be described in more detail. FIG. 5 is a view for explaining the operation relation between the back camera 3 and the adhered-substance removing apparatus 1 according to the embodiment.

The operation relation shown in FIG. 5 is an operation relation in the case where the driver puts the vehicle 100 in reverse by operating the gears. As shown in FIG. 5, if the vehicle 100 is put in reverse, the trigger information is generated, and if the acquiring unit 11 acquires the trigger information, the adhered-substance removing apparatus 1 performs preparation for injection, such as air compression.

Meanwhile, if the driver puts the vehicle in reverse by operating the gears and the trigger information is generated as a result, the trigger information is input to the back camera 3. Then, images acquired by the back camera 3 are displayed, for example, on the display unit of the navigator. It is assumed that such images show raindrops on the lens 30 of the back camera 3.

After the preparation for injection finishes, the adhered-substance removing apparatus 1 stands by to inject compressed air until a delay time for adjusting the timing of injection elapses. The delay time is set by the instructing unit 12.

Specifically, the instructing unit 12 sets the delay time such that the delay time ends in the period of the first cycle when the backing warning tone is output. However, the instructing unit 12 may set the delay time such that the delay time ends at the rising timing of the first cycle. In this case, the adhered-substance removing apparatus 1 can perform injection of compressed air at the same time as output of the backing warning tone.

Also, the instructing unit 12 may set the delay time such that the delay time ends in the period of the next cycle when the backing warning tone is output. In this case, the adhered-substance removing apparatus 1 can mask injection sound produced by injection of compressed air with the backing warning tone produced in the next cycle.

After the delay time elapses, the adhered-substance removing apparatus 1 injects compressed air from the nozzle 13b. In other words, the adhered-substance removing apparatus 1 performs injection of compressed air in the period of the first cycle when the backing warning is output. The volume of injection sound which is produced by injection of compressed air is lower than that of the backing warning tone. Therefore, by masking injection sound with the backing warning tone, it is possible to drown out injection sound “pushu” by the backing warning tone “bee”.

Meanwhile, from the lens 30 of the back camera 3, raindrops are removed by compressed air injected from the nozzle 13b. As a result, clear images acquired by the back camera 3 are displayed, for example, on the display unit of the navigator.

In the above-described example, the number of times injection of compressed air is performed in the period of the first cycle when the backing warning is output is one; however, for example, the number of times injection of compressed air is performed in the period of the first cycle when the backing warning is output may be two or more.

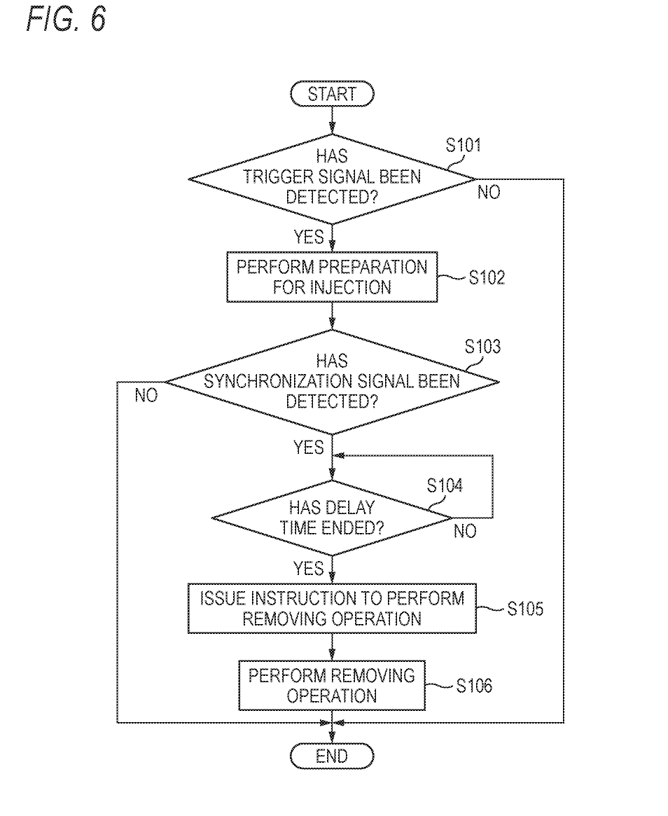

Now, with reference to FIG. 6, a proceeding procedure which is performed by the adhered-substance removing apparatus 1 according to the embodiment will be described. FIG. 6 is a flow chart illustrating an example of the proceeding procedure which is performed by the adhered-substance removing apparatus 1 according to the embodiment.

As shown in FIG. 6, first, the adhered-substance removing apparatus 1 determines whether the trigger signal ST has been detected (STEP S101). In the case where the trigger signal ST has not been detected (“No” in STEP S101), the adhered-substance removing apparatus 1 finishes the processing.

Meanwhile, in the case where the trigger signal ST has been detected (“Yes” in STEP S101), the adhered-substance removing apparatus 1 performs preparation for injection, such as air compression (STEP S102). Subsequently, the adhered-substance removing apparatus 1 determines whether the synchronization signal SS has been detected (STEP S103). In the case where the synchronization signal SS has not been detected (“No” in STEP S103), the adhered-substance removing apparatus 1 finishes the processing.

Meanwhile, in the case where the synchronization signal SS has been detected (“Yes” in STEP S103), the adhered-substance removing apparatus 1 proceeds to the process of STEP S104. Then, the adhered-substance removing apparatus 1 determines whether the delay time has ended.

In the case where it is determined that the delay time has not ended yet (“No” in STEP S104), the adhered-substance removing apparatus 1 repeatedly performs the process of STEP S104 until the delay time ends.

Meanwhile, in the case where it is determined that the delay time has ended (“Yes” in STEP S104), the adhered-substance removing apparatus 1 issues an instruction to perform the operation of removing adhered substances from the lens 30 of the camera 3 (STEP S105). Subsequently, the adhered-substance removing apparatus 1 performs the removing operation in a period when the external device 2 outputs the tone (STEP S106), and finishes the processing.

As described above, the adhered-substance removing apparatus 1 according to the embodiment includes the acquiring unit 11, the instructing unit 12, and the removing unit 13.

The acquiring unit 11 acquires the output information on the tone to be output from the external device 2 mounted on the vehicle 100. On the basis of the output information, the instructing unit 12 issues the instruction to perform the operation of removing adhered substances from the lens 30 of the camera 3 installed on the outside of the vehicle 100 in a period when the external device 2 outputs the tone. On the basis of the instruction from the instructing unit 12, the removing unit 13 performs the removing operation.

As a result, the adhered-substance removing apparatus 1 according to the embodiment can make noise produced by the adhered-substance removing operation unobtrusive. Therefore, as a result, it is possible to reduce noise according to the adhered-substance removing operation.

Also, as described above, the acquiring unit 11 acquires output information on a tone which is repeated in a cycle, as the output information, and the instructing unit 12 issues the instruction to perform the removing operation in a period of a cycle when the tone is output.

Therefore, on the basis of the output information on the tone which is repeated in the cycle, the adhered-substance removing apparatus 1 according to the embodiment can effectively make noise produced by the adhered-substance removing operation unobtrusive.

Also, as described above, the acquiring unit 11 also acquires the trigger information for activating the adhered-substance removing apparatus, and after the acquiring unit acquires the trigger information, if the predetermined delay time elapses, the instructing unit 12 issues the instruction to perform the removing operation.

Therefore, the adhered-substance removing apparatus 1 according to the embodiment can surely mask operating sound produced by the adhered-substance removing operation with the tone output from the external device 2.

Also, as described above, the acquiring unit 11 acquires the information representing that the vehicle 100 has been put in reverse, as the trigger information.

Therefore, the adhered-substance removing apparatus 1 according to the embodiment can remove adhered substances from the lens 30 of the camera 3 in a period when the backing warning tone is output from the external device 2 due to backing of the vehicle 100.

Also, as described above, the removing unit 13 removes adhered substances from the camera 3 by injecting compressed air. Therefore, the adhered-substance removing apparatus 1 according to the embodiment can mask injection sound produced by injection of compressed air with the backing warning tone output from the external device 2.

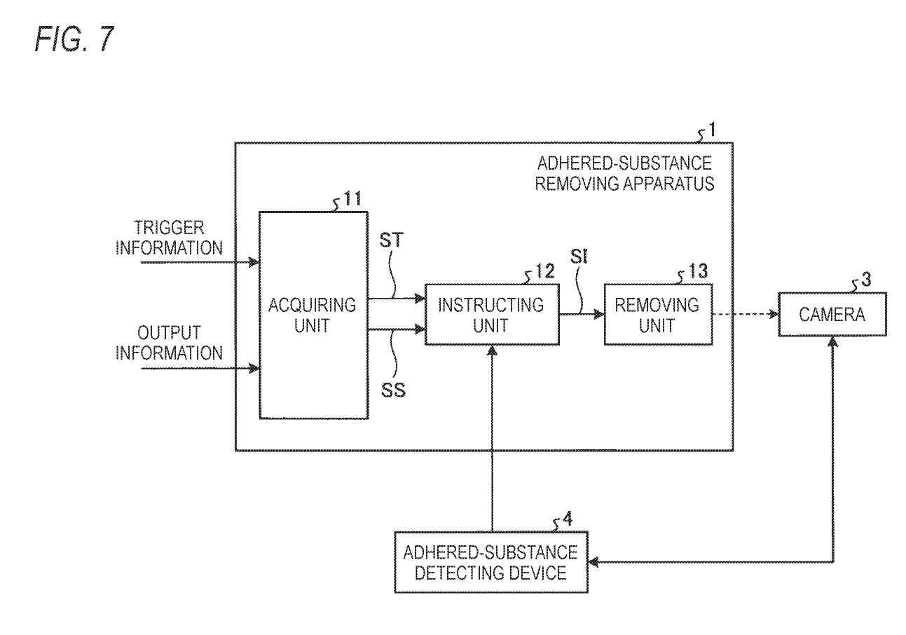

Now, with reference to FIG. 7, an adhered-substance removing apparatus 1 according to a modification of the embodiment will be described. FIG. 7 is a block diagram illustrating an example of the configuration of the adhered-substance removing apparatus 1 according to the modification of the embodiment. Also, of components shown in FIG. 7, components identical to the components shown in FIG. 2 are denoted by the same reference symbols as the reference symbols shown in FIG. 2, and a description thereof will not be made here.

As shown in FIG. 7, the adhered-substance removing apparatus 1 according to the modification is different from the configuration of FIG. 2 in that the instructing unit 12 issues instructions to perform the removing operation depending on detection results obtained by an adhered-substance detecting device 4 configured to detect adhered substances on the lens 30 of the camera 3.

Specifically, the adhered-substance detecting device 4 detects adhered substances on the lens 30, on the basis of images acquired by the camera 3. Then, the adhered-substance detecting device 4 outputs the detection result to the instructing unit 12.

In the case where a detection value obtained by the adhered-substance detecting device 4 is equal to or larger than a predetermined value, the instructing unit 12 issues an instruction to perform the operation of removing adhered substances from the lens 30 of the camera 3 installed on the outside of the vehicle 100 a plurality of times in a period when the external device 2 outputs the tone.

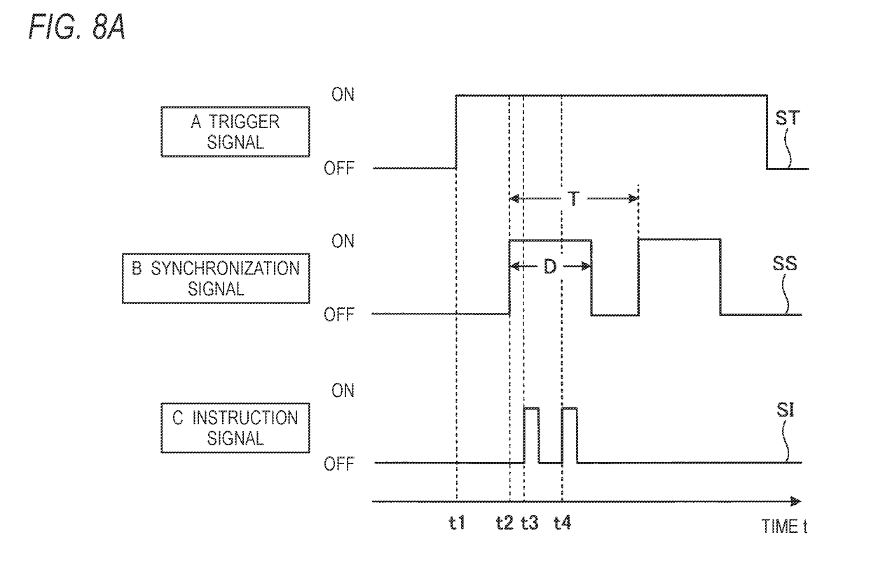

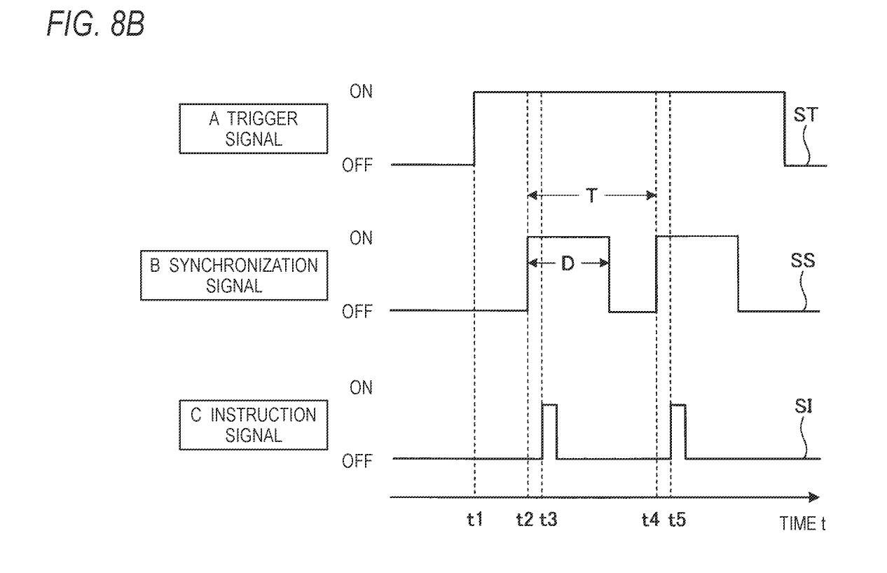

The above-described process which is performed by the instructing unit 12 will be described in detail with reference to FIG. 8A and FIG. 8B. FIG. 8A is a view illustrating an example of the process which is performed by the instructing unit 12 according to the modification of the embodiment. Also, FIG. 8B is a view illustrating another example of the process which is performed by the instructing unit 12 according to the modification of the embodiment.

Also, in FIG. 8A and FIG. 8B, “A” represents the ON/OFF state of the trigger signal ST, and “B” represents the ON/OFF state of the synchronization signal SS, and “C” represents the ON/OFF state of the instruction signal SI.

As shown in FIG. 8A, in the case where the detection value obtained by the adhered-substance detecting device 4 is equal to or larger than the predetermined value, the instructing unit 12 outputs an instruction signal SI to the removing unit 13 such that the removing unit performs the removing operation twice in the period D of the first cycle T of the synchronization signal SS when the backing warning tone is output. In this example, at the time t3 and a time t4, the instruction signal SI is switched from the OFF state to the ON state. Also, between the time t3 and the time t4, preparation for injection such as air compression for performing the second removing operation is performed.

Also, as shown in FIG. 8B, the instructing unit 12 may output an instruction signal SI to the removing unit 13 such that the removing unit performs the removing operation once in each of the periods of the first cycle T and the next cycle of the synchronization signal SS when the backing warning tone is output. In this example, at the time t3 and a time t5, the instruction signal SI is switched from the OFF state to the ON state.

Also, it is desirable that the time interval between the time t2 of the rising of the synchronization signal SS and the time t3 of the rising of he instruction signal SI is approximately equal to the time interval between the time t4 of the rising of the synchronization signal SS and the time t5 of the rising of the instruction signal SI. In this case, it is possible to mask injection sound produced by performing the removing operation the plurality of times with the backing warning tone while further suppressing injection sound from causing an uncomfortable feeling.

As described above, in the case where the detection value obtained by the adhered-substance detecting device 4 is equal to or larger than the predetermined value, the instructing unit 12 instructs the removing unit 13 to perform the removing operation the plurality of times when the backing warning tone is output from the external device 2.

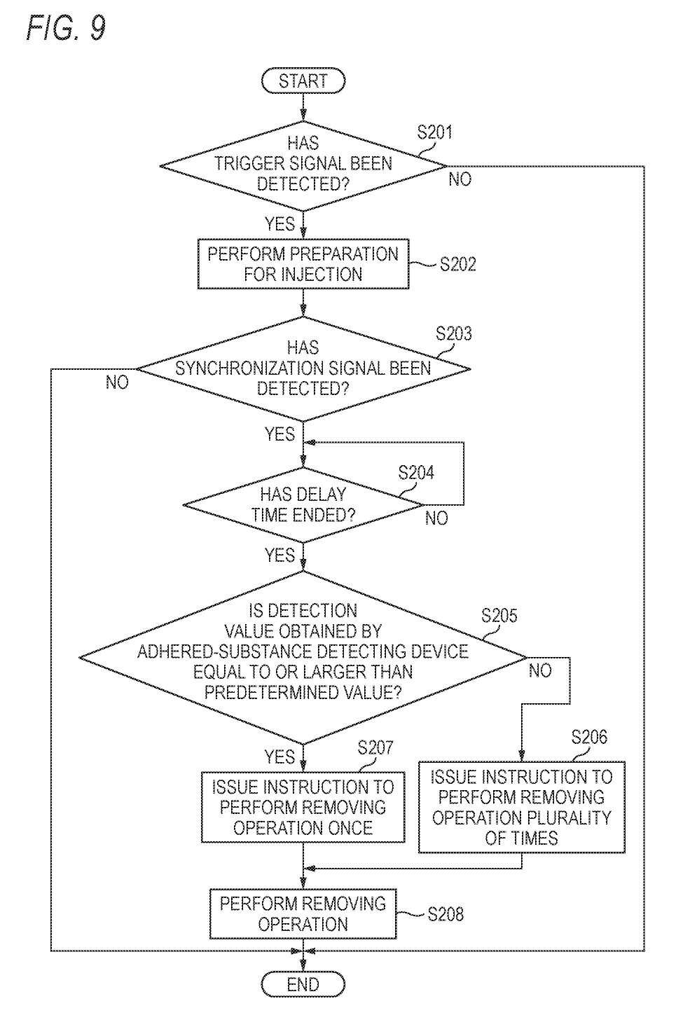

Now, with reference to FIG. 9, a proceeding procedure which is performed by the adhered-substance removing apparatus 1 according to the modification will be described. FIG. 9 is a flow chart illustrating an example of the proceeding procedure which is performed by the adhered-substance removing apparatus 1 according to the modification of the embodiment.

Also, processing from STEP 5201 to STEP 5204 shown in FIG. 9 is identical to the processing from STEP S101 to STEP S104 shown in FIG. 6, and thus without a repetitive description thereof, processing from STEP 5205 will be described.

Also, the flow chart shown in FIG. 9 is an example of the case where if the detection value obtained by the adhered-substance detecting device 4 is equal to or larger than the predetermined value, the removing operation is performed the plurality of times in the period D of the first cycle T of the synchronization signal SS when the backing warning tone is output.

As shown in FIG. 9, in the process of STEP 5205, the adhered-substance removing apparatus 1 determines whether the detection value obtained by the adhered-substance detecting device 4 is equal to or larger than the predetermined value, or not. In the case where the detection value is smaller than the predetermined value (“No” in STEP S205), the adhered-substance removing apparatus 1 issues the instruction to perform the operation of removing adhered substances from the lens 30 of the camera 3 once (STEP S206). Then, the adhered-substance removing apparatus 1 performs the removing operation once in the period when the external device 2 outputs the tone (STEP S208), and finishes the processing.

Meanwhile, in the case where the detection value is equal to or larger than the predetermined value (“Yes” in STEP S205), the adhered-substance removing apparatus 1 issues the instruction to perform the operation of removing adhered substances from the lens 30 of the camera 3 the plurality of times (STEP S207). Then, the adhered-substance removing apparatus 1 performs the removing operation the plurality of times in the period when the external device 2 outputs the tone (STEP S208), and finishes the processing.

Also, in the case where the instructing unit 12 determines that the detection value is equal to or larger than the predetermined value, if it is determined from a predetermined-value data table that a related value is within a value range representing that it is required to perform the removing operation twice, the adhered-substance removing apparatus 1 performs the removing operation twice.

Also, the adhered-substance removing apparatus 1 may be configured such that in the case where the instructing unit 12 determines that the detection value is smaller than the predetermined value, if it is determined from the predetermined-value data table that the related value is not within a value range representing that it is required to perform the removing operation once, the adhered-substance removing apparatus does not perform the removing operation.

As described above, in the adhered-substance removing apparatus 1 according to the modification of the embodiment, the instructing unit 12 issues the instructions to perform the removing operation, depending on detection results obtained by the adhered-substance detecting device 4 configured to detect adhered substances on the lens 30.

Therefore, the adhered-substance removing apparatus 1 according to the modification of the embodiment can make noise produced by the adhered-substance removing operation unobtrusive and can surely remove adhered substances from the lens 30 of the camera 3.

Also, as described above, in the adhered-substance removing apparatus 1 according to the modification of the embodiment, in the case where a detection value obtained by the adhered-substance detecting device 4 is equal to or larger than the predetermined value, the instructing unit 12 issues the instruction to perform the removing operation the plurality of times.

Therefore, the adhered-substance removing apparatus 1 according to the modification of the embodiment can make noise produced by the adhered-substance removing operation unobtrusive and can more surely remove adhered substances from the lens 30 of the camera 3.

Also, although the case where the adhered-substance removing apparatus 1 according to the embodiment is attached near the back camera 3 has been described as an example, the adhered-substance removing apparatus may be attached near a front camera or a side camera installed on the outside of the vehicle 100.

In this form, trigger information is, for example, information representing that the engine has been started by a key sensor, an ignition switch, or the like. Also, output information on a tone to be output from the external device 2 is, for example, information on a tone for informing the driver that the engine has been started.

However, the output information may not be information representing timings to switch a tone which is repeated in a cycle between the ON state and the OFF state, and may be, for example, information representing timings to switch a tone having one period between the ON state and the OFF state. In this case, it is desirable that the ON state of the tone (the state where the tone is output) is longer.

In other words, in this form, in the period when the tone is output from the external device 2 due to start of the engine, the adhered-substance removing apparatus removes adhered substances from the lens of the front camera or the side camera.

Also, although the adhered-substance removing apparatus 1 according to the embodiment removes adhered substances from the lens 30 of the camera 3 in a period when the tone is output from the external device 2, on the basis of the trigger information and the output information on the tone, the present invention is not limited thereto.

As another form, the adhered-substance removing apparatus may remove adhered substances from the lens 30 of the camera 3 in a period when the tone is output from the external device 2, on the basis of only the output information on the tone.

In other words, the adhered-substance removing apparatus 1 may not be configured to be activated after the trigger information is input, and may be configured to be activated if output information on a tone is input as a trigger signal from the external device 2.

In this form, as examples of the external device 2, a navigator, a car audio device, and so on can be taken. In this case, for example, on the basis of output information on a tone output from the car audio device, the operation of removing adhered substances from the lens 30 of the camera 3 is performed in a period when the car audio device outputs the tone.

Also, as a further form, on the basis of sound output information output from a sound collecting microphone mounted on the vehicle 100, the operation of removing adhered substances from the lens 30 of the camera 3 may be performed in a period when the sound collecting microphone is collecting sound of a predetermined volume from the inside and outside of the vehicle 100.

Even in this case, it is possible to mask operating sound produced by the adhered-substance removing operation with the sound of the predetermined volume produced inside or outside the vehicle 100.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An adhered-substance removing apparatus comprising:
an acquiring unit configured to acquire output information on a tone to be output from an external device mounted on a vehicle;
an instructing unit configured to issue, based on the output information, an instruction to perform an operation of removing adhered substances from a lens of a camera installed on the outside of the vehicle in a period when the external device outputs the tone; and
a removing unit configured to perform the operation of removing based on the instruction from the instructing unit.

2. The adhered-substance removing apparatus according to claim 1, wherein:
the acquiring unit acquires output information on a tone which has periodicity, as the output information, and
the instructing unit issues an instruction to perform the operation of removing in a period when the tone which has periodicity.

3. The adhered-substance removing apparatus according to claim 1, wherein:
the acquiring unit further acquires trigger information for activating the adhered-substance removing apparatus, and
the instructing unit issues the instruction to perform the operation of removing if a predetermined delay time elapses after the trigger information is acquired.

4. The adhered-substance removing apparatus according to claim 3, wherein:
the acquiring unit acquires information representing that a gear position of the vehicle has been entered in a reverse gear, as the trigger information.

5. The adhered-substance removing apparatus according to claim 1, wherein:
the removing unit removes adhered substances from the camera by injecting compressed air.

6. The adhered-substance removing apparatus according to claim 1, wherein:
based on a detection result obtained by an adhered-substance detecting device configured to detect adhered substances on the lens, the instructing unit issues an instruction to perform the operation of removing.

7. The adhered-substance removing apparatus according to claim 6, wherein:
in a case where a detection value obtained by the adhered-substance detecting device is equal to or larger than a predetermined value, the instructing unit issues an instruction to perform the operation of removing a plurality of times.

8. An adhered-substance removing method comprising:
acquiring output information on a tone to be output from an external device mounted on a vehicle;
issuing an instruction to perform an operation of removing adhered substances from a lens of a camera installed on the outside of the vehicle in a period when the external device outputs the tone, based on the output information acquired in the acquiring; and
performing the operation of removing on the basis of the instruction issued in the instructing.
